(19) United States
(12) Patent Application Publication
(10) Pub. No.: US 2013/0014001 A1
(43) Pub. Date: Jan. 10, 2013

(54) DEVELOPING PERIODIC CONTRACT APPLICATIONS

(76) Inventors: BORIS BRAUN, Eppingen (DE); Thorsten Marcus Dunz, Schwetzingen (DE); Dietmar Kern, Schorndorf (DE)

(21) Appl. No.: 13/178,516

(22) Filed: Jul. 8, 2011

(51) Int. Cl. G06F 17/00

(52) U.S. Cl. 715/234

(57) ABSTRACT

Various embodiments of systems and methods for developing periodic contract application are described herein. In one aspect, the method includes receiving an identification of a periodic contract application to be developed, assigning one or more fields to the identified to-be-developed periodic contract application in a master database table, receiving one or more application specific master data corresponding to the one or more fields assigned to the to-be-developed periodic contract application, receiving business dependent logic from a user, and integrating the business dependent logic with at least one of the application specific master data and one or more predefined User Interfaces (UIs) including periodic data to generate the periodic contract application. The user (developer) customizes the master data (non-periodic data) and provides the business dependent logic while the periodic data and logging and error handling functionality are automatically handled.

### FIELD

The technical field relates generally to periodic contract applications, and more particularly to developing periodic contract applications with preconfigured periodic features.

### BACKGROUND

Periodic contract applications are typically developed to execute periodic tasks. For example, a periodic contract application may be developed to generate (execute) a monthly Bank Statement (a periodic task). Many enterprises, e.g., a bank or other financial institutions, execute multiple periodic tasks such as generating the monthly Bank Statement, generating a yearly interest statement, performing a monthly credit check, etc. Usually, for each of these periodic tasks a separate periodic contract application is developed.

Periodic contract applications usually have some common features. For example, periodic contract applications have a User Interface (UI) for an end user to specify a periodicity of the periodic task (i.e., a time period after which the task is to be repeated). Different periodic contract applications may be developed by different developers and each developer separately writes code for developing the common feature(s). For example, each developer may write code for developing the UI for specifying the periodicity. Similarly, each developer may write code for handling the non-working days, handling errors, and generating reports, etc.

However, it might be a waste of resource, time, and effort to develop the code for the same common features separately by different developers (i.e., redundant development). Further, the UI developed by different developers for the same feature (e.g., periodicity) might have different or inconsistent look and feel. Again, it might be inconvenient for the end user to visualize or use different types of UIs for the same common feature (e.g., periodicity) in different contract applications. Moreover, it might be a waste of effort and time to separately test the code written by different developers for the same common feature(s). Also, the code written by different developers, for the same common features, may include different kind of bugs/errors. Finally, separate databases may be required by the separate (different) periodic contract applications to store their respective data. At last, it might be inefficient to waste effort in developing the common features instead of focusing on the business dependent logic (i.e., the code for developing the actual business task).

### SUMMARY OF THE INVENTION

Various embodiments of systems and methods for developing periodic contract applications are described herein. In one aspect, a method includes receiving an identification corresponding to a periodic contract application to be developed, assigning one or more fields to the identified to-be-developed periodic contract application in a master database table, receiving one or more application specific master data corresponding to the one or more fields assigned to the to-be-developed periodic contract application, receiving business dependent logic from a user, and integrating the business dependent logic with at least one of the one or more application specific master data and one or more predefined User Interfaces (UIs) to generate the periodic contract application. A predefined UI includes one or more periodic data. The user (developer) typically provides the master data (non-periodic data) and the business dependent logic. The periodic data and the logging and error handling functionality are automatically handled. Therefore, the periodic contract application(s) can be easily and efficiently developed. Further, the look and feel of the predefined UI (including the periodic data) is uniform and consistent in all the developed periodic contract applications.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1A is a block diagram of a periodic application development tool for developing periodic contract application(s), according to an embodiment of the invention.

FIG. 1B is a block diagram of the periodic application development tool coupled to a master database table for developing a periodic contract application, according to an embodiment of the invention

FIG. 2 is an exemplary screen display of a predefined User Interface (UI) including periodic data to be integrated with a to-be-developed periodic contract application, according to an embodiment of the invention.

FIG. 3 is a block diagram of the periodic contract application with multiple contract agreements associated with it, according to an embodiment of the invention.

FIG. 4 is a block diagram of an event table for maintaining exception(s) related to one or more contract agreements, according to an embodiment of the invention.

FIG. 5 is a block diagram of a transactional database table generated to store an execution deadline of the one or more contract agreements, according to an embodiment of the invention.

FIG. 6 illustrates an exemplary transactional database table including the execution deadline of the one or more contract agreements, according to an exemplary embodiment of the invention.

FIG. 7 is a flow chart illustrating the steps performed to develop the periodic contract application, according to various embodiments of the invention.

FIG. 8 is a flow chart illustrating the steps performed to determine and store the execution deadline of the one or more contract agreements in the transactional database table, according to an embodiment of the invention.

FIG. 9 is a flow chart illustrating the steps performed to execute the contract agreement related to the periodic contract application, according to an embodiment of the invention.

FIG. 10 is a block diagram of an exemplary computer system, according to an embodiment of the invention.

### DETAILED DESCRIPTION

Embodiments of techniques for developing periodic contract applications are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

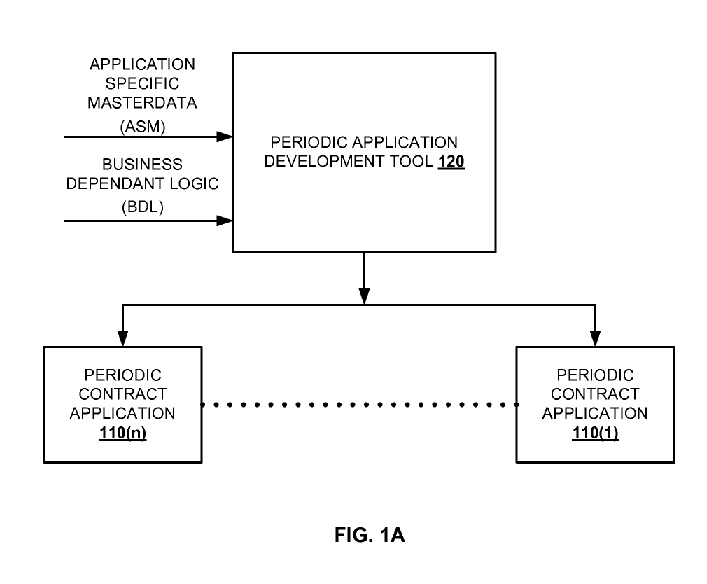

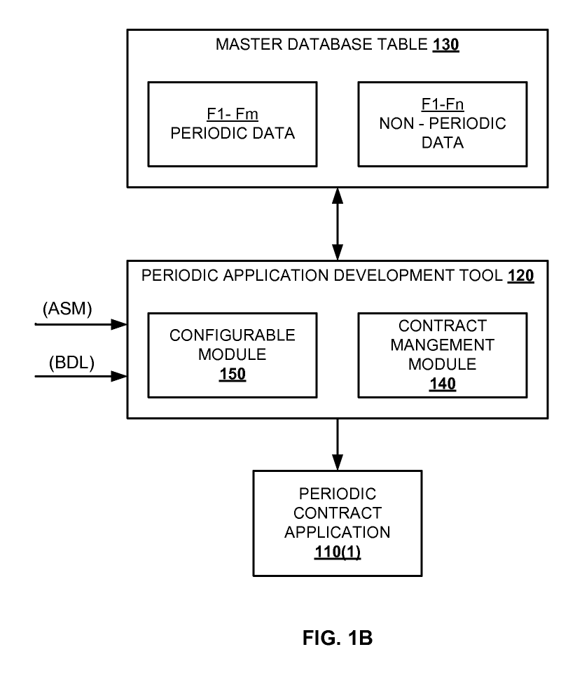

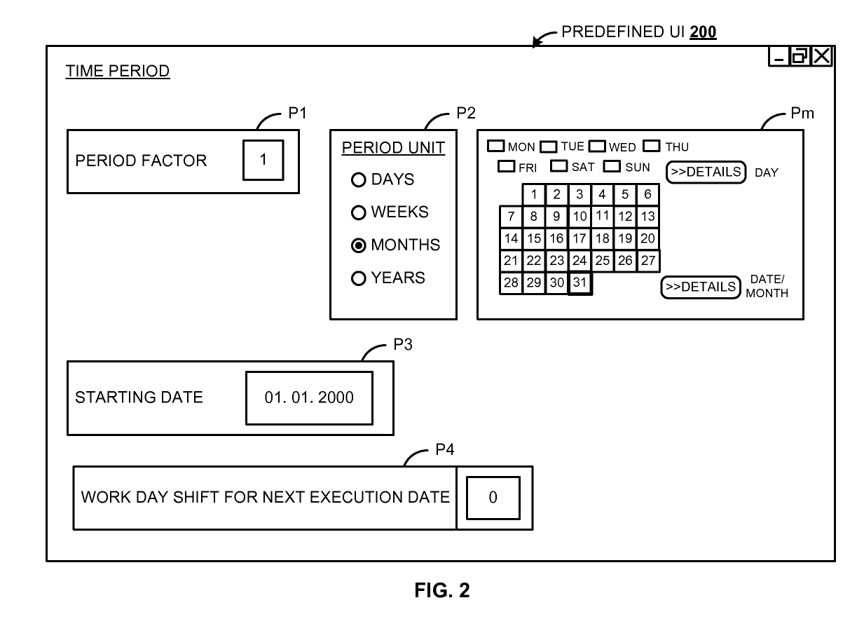

FIG. 1A illustrates one embodiment of a periodic application development tool 120 for developing periodic contract applications 110 (1-n). The periodic application development tool 120 receives an identification of a to-be-developed periodic contract application 110(1). Essentially, a user (developer) provides the identification for the to-be-developed periodic contract application 110(1). For example, the user may provide a name for the to-be-developed periodic contract application 110(1). Once the identification is provided, the user may enter/include one or more application specific master data (ASM) and a business dependent logic (BDL) to the periodic application development tool 120. In one embodiment, the periodic application development tool 120 may prompt the user to enter (provide) the application specific master data (ASM) and the business dependent logic (BDL). Typically, the user provides the one or more application specific master data (ASM) and the business dependent logic (BDL) according to a specific business requirement of the to-be-developed periodic contract application 110(1). Once the application specific master data (ASM) and the business dependent logic (BDL) is provided, the periodic application development tool 120 integrates the application specific master data (ASM), the business dependent logic (BDL), and one or more predefined User Interfaces (UIs) (e.g., the predefined UI 200 (refer to FIG. 2)) to generate the periodic contract application 110(1).

In one embodiment, as illustrated in FIG. 1B, the periodic application development tool 120 may comprise a contract management module 140 and a configurable (customizable) module 150. The configurable module 150 may be used by the user (developer) to specify or provide the identification of the to-be-developed periodic contract application 110(1). For example, the configurable module 150 may be used by the user (developer) to specify an identifier for a to-be-developed periodic contract application 110(1) for identification. Once the identifier is provided, the contract management module 140 assigns one or more fields (f1-fn) to the to-be-developed periodic contract application 110(1) in a master database table 130. In one embodiment, the periodic application development tool 120 and the master database table 130 may be separate entities communicatively coupled to each other. In another embodiment, the master database table 130 may be a part of the periodic application development tool 120.

Once the fields (f1-fn) of the master database table 130 are assigned to the to-be-developed periodic contract application 110(1), the user may configure the assigned fields (f1-fn). Essentially, the user provides/defines the application specific master data (ASM) corresponding to the one or more assigned fields (f1-fn). The user may include or enter the business dependent logic (BDL) for the to-be-developed periodic contract application 110(1). The business dependent logic (BDL) may be entered through the configurable module 150. Once the business dependent logic (BDL) is entered, the contract management module 140 integrates the business dependent logic (BDL) with at least one of the one or more application specific master data (ASM) and the one or more predefined User Interfaces (UIs) (e.g., the predefined UI 200 (refer to FIG. 2)) to generate the periodic contract application 110(1). The generated periodic contract application 110(1) may be stored in a storage medium (not shown).

Each periodic contract application 110 (1-n) is developed for a specific purpose. For example, the periodic contract application 110(1) may be developed for ‘Bank Statement’ while the periodic contract application 110(2) may be developed for ‘interest settlement’, etc. Each of the periodic contract applications 110 (1-n) has the identifier. The identifier may be made of alphanumeric characters and symbols. For example, the identifier may be a name (e.g., ‘Bank Statement’) of the periodic contract application 110(1). Essentially, the user provides the identifier (e.g., name) for the to-be-developed periodic contract application 110(1). Once the user specifies the identifier, the to-be-developed periodic contract application 110(1) gets registered (identified). In one embodiment, the identifier may be specified through the configurable module 150. In another embodiment, the contract management module 140 may automatically provide an internal identifier (e.g., an ID) to the to-be-developed periodic contract application 110(1).

Once the to-be-developed periodic contract application 110(1) is identified, the contract management module 140 assigns the fields (f1-fn) to the to-be-developed periodic contract application 110(1) in the master database table 130. In one embodiment, a predefined number of fields may be assigned to the to-be-developed periodic contract application 110 (1). For example, the to-be-developed periodic contract application 110 (1) may be assigned 20 fields in the master database table 130. The fields (f1-fn), assigned to the to-be-developed periodic contract application 110(1), may be configured by the user.

Essentially, the user defines the one or more master data (i.e., the application specific master data (ASM)) corresponding to the one or more assigned fields (f1-fn). The application specific master data (ASM) is defined specifically based upon the business requirement of the to-be-developed periodic contract application 110(1). For example, the application specific master data (ASM) ‘account number’ and ‘receiver's address’ may be defined specifically for the to-be-developed periodic contract application ‘Bank Statement.’ Essentially, the user maps the one or more application specific master data (ASM) to the corresponding one or more fields (f1-fn). For example, the application specific master data (ASM) ‘account number’ and ‘receiver's address’ may be mapped to the fields, f1-f2, respectively, in the master database table 130.

The user can specify various attributes (characteristics) for the application specific master data (ASM) (i.e., fields (f1-fn)). For example, the user may define a type of the application specific master data (ASM) or field (i.e., whether the application specific master data (ASM) or field is alphanumeric, numeric, or alphabetic, etc) and a length (size) of the application specific master data (ASM) or field (i.e., 20 characters long, 40 characters long, etc).

The user may compose or enter the business dependent logic (BDL) for the to-be-developed periodic contract application 110(1). Essentially, the business dependent logic (BDL) is composed based upon a specific business requirement of the to-be-developed periodic contract application 110(1). The user may enter (implement) the business dependent logic (BDL) through the configurable module 150. For example, the user may enter (implement) the following business dependent steps for printing the ‘Bank Statement’ through the configuration module 150:
Select the one or more periodic and non periodic data to be printed;
Perform formatting;
Select Channel (e.g., paper, email, fax, etc); and
Print and add copy to a second receiver.

The configurable module 150 may be any one of a user exit, call functions, BAdI (Business Add In), BTEs (Business Transaction Events), etc. The configurable module 150 may be a part of the contract management module 140 or may be a separate entity. In one embodiment, the user may include (e.g., implement) the business dependent logic (BDL) prior to mapping the application specific master data (ASM) to the fields (f1-fn).

Essentially, the business dependent logic (BDL) (e.g., the process dependent steps), the one or more application specific master data (ASM), and the predefined UI or selection screen (e.g., the UI 200) may be integrated to generate the periodic contract application 110(1). In one embodiment, the contract management module 140 may integrate the business dependent logic (BDL), the one or more application specific master data (ASM), and the predefined UI 200 (refer to FIG. 2) to generate the periodic contract application 110(1).

The predefined UI 200 includes the one or more periodic data (p1-pm). The periodic data (p1-pm) corresponds to one or more fields (F1-Fm) of the master database table 130. Essentially, the fields (F1-Fm) are preconfigured corresponding to the predefined periodic data (p1-pm). Alternately, the fields (F1-Fm) are reserved for the predefined periodic data (p1-pm), respectively.

FIG. 2 illustrates the predefined UI 200 including the periodic data (p1-pm). In one embodiment, the periodic data (p1-pm) may be define as:
i.) Periodic factor (p1): indicates a value of a time period after which the periodic contract application has to be executed repeatedly. The periodic factor p1 may be any natural number, e.g., 2, 3, 4, or 10, etc.
ii.) Period Unit (p2): indicates a unit of measurement of the time period after which the periodic contract application has to be executed repeatedly. For example, the period unit p2 may be one of day(s), month(s), year, week(s), etc.
iii.) Starting Date (p3): indicates a date from which the counting of periodic factor p1 has to be started. For example, if the periodic factor is “2”, period unit is “days”, and the starting date is Jan. 2, 2011 then the periodic contract application may be executed after 2 days from January 2^{nd}, i.e., on 4 Jan. 2011.
iv.) WrkDyShft for Next Ex Dat (p4): indicates if the execution of the periodic contract application falls on weekend (non-working day) then whether to shift the execution to 1 or 2 day(s) before or after. For example, if the execution of the periodic contract application falls on a ‘Saturday’ then it can be shifted either to ‘Friday’ (1 day before) or to ‘Monday’ (2 days after). In one embodiment, the WrkDyShft for Next Ex Dat (p4) may be automatically calculated 1 day before.

v.) Details field (pm): indicates details related to the period unit (p2). For example, details field (pm) may include a calendar to illustrate the details related to month(s) and/or year, etc.

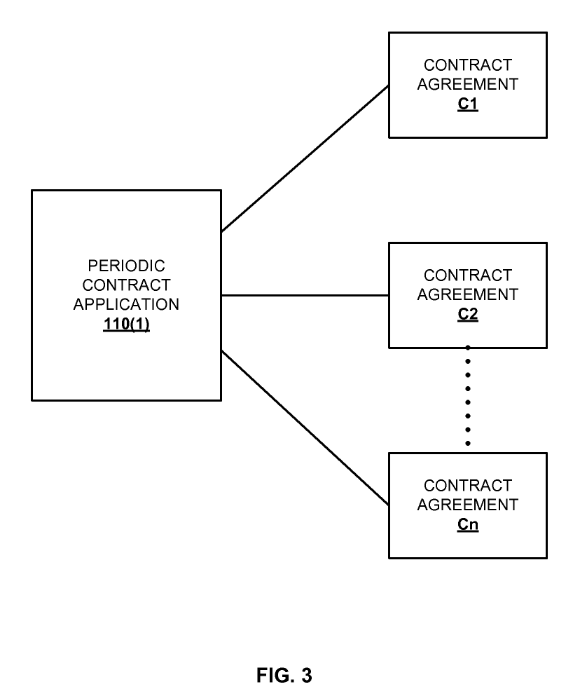

Essentially, the periodic data (p1-pm) determines a periodicity (time period after which the periodic contract application 110(1) is executed periodically). For example, the periodic contract application 110(1) ‘Bank Statement’ may be executed once in a month (p1=1 and p2=month). Essentially, one or more instances or contract agreements (C1-Cn) (refer to FIG. 3) associated with the periodic contract application 110(1) are executed. The one or more contract agreements (C1-Cn) of the periodic contract application 110(1) may be created by an end user (e.g., bank manager). If the periodic contract application 110(1) is the ‘Bank Statement’, the end user may create contract agreements C1 (Bank Statement_for_account_Num_101), C2 (Bank Statement_for_account_Num_105), and C3 (Bank Statement_for_account_Num_106), etc.

In one embodiment, the end user specifies (selects or enters) the values of the periodic data (p1-pm) or the values of the fields (F1-Fm) for the contract agreements (C1-Cn). The end user also specifies the values of the application specific master data (ASM) or the values of the fields (f1-fn) for the contract agreements (C1-Cn). Essentially, the end user specifies the values of the periodic data (p1-pm) and the non periodic data (application specific master data (ASM)) through the predefined UI 200.

The values of the non periodic data may be stored in the corresponding fields (f1-fn) and the values of the periodic data (p1-pm) may be stored corresponding to the fields (F1-Fm) against the contract agreement C1 in the master database table 130. For example, an exemplary template of the master database table 130 storing the values of the periodic data (p1-pm) (corresponding to the periodic fields (F1-Fm)) and the non periodic data (corresponding to the non periodic fields (f1-fn)) of the contract agreement C1 may be as follows:

| | | | Periodic | Periodic | Periodic | Non | Non |
|---|---|---|---|---|---|---|---|
| | | | field F1 | field F2 | field F3 | periodic | periodic |
| | | Contract | (periodic | (period | (starting | field f1 | field f2 |
| Contract | Application | agreement | factor, | unit, i.e., | date, i.e., | (account | (receivers |
| Id | name/no. | no./id | i.e., p1) | p2) | p3) | no.) | address) |
| #1 | 110(1) | C1 | 1 | Month | 01.01.2011 | 001 | ABC |

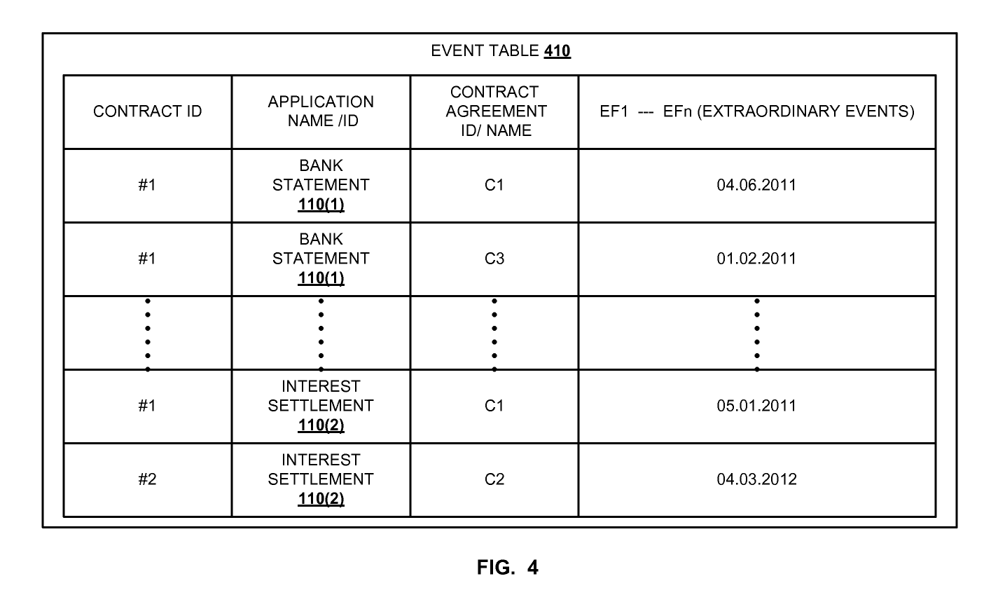

The end user may also specify an exception (extraordinary events/dates) related to the contract agreement C1. For example, as illustrated in the above exemplary template, the periodic data for the contract agreement C1 specifies to print Bank Statement 1^{st} of every month (periodic factor (p1)=1; periodic unit (p2)=Months; and starting date (p3)=01.01.2011), the exception for the contract agreement C1 may be specified as to print the statement on 6^{th} for the month of April, 2011. The exception (extraordinary events) related to the contract agreement C1 may be specified through the predefined UI. The exception (extraordinary event) related to the contract agreement C1 may be stored in an event table 410 (refer to FIG. 4). In one embodiment, one or more fields (EF1-EFn) may be assigned to the contract agreement(s) related to the one or more periodic contract applications 110 (1-n) in the event table 410, as illustrated in FIG. 4. In another embodiment, one or more fields (EF1-EFn) may be assigned to those contract agreement(s) that have extraordinary event(s) or exceptions.

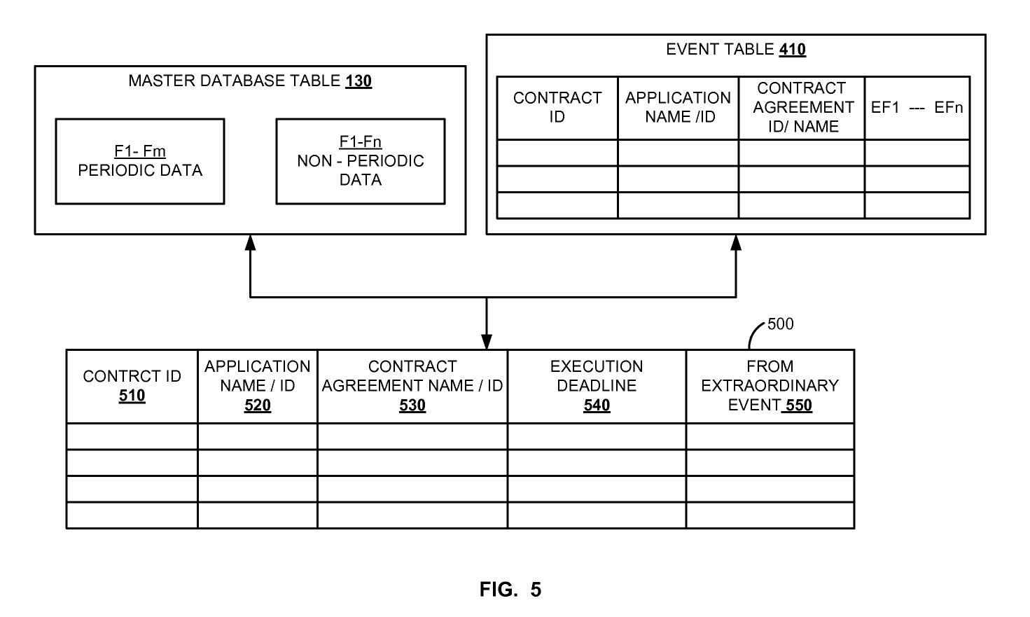

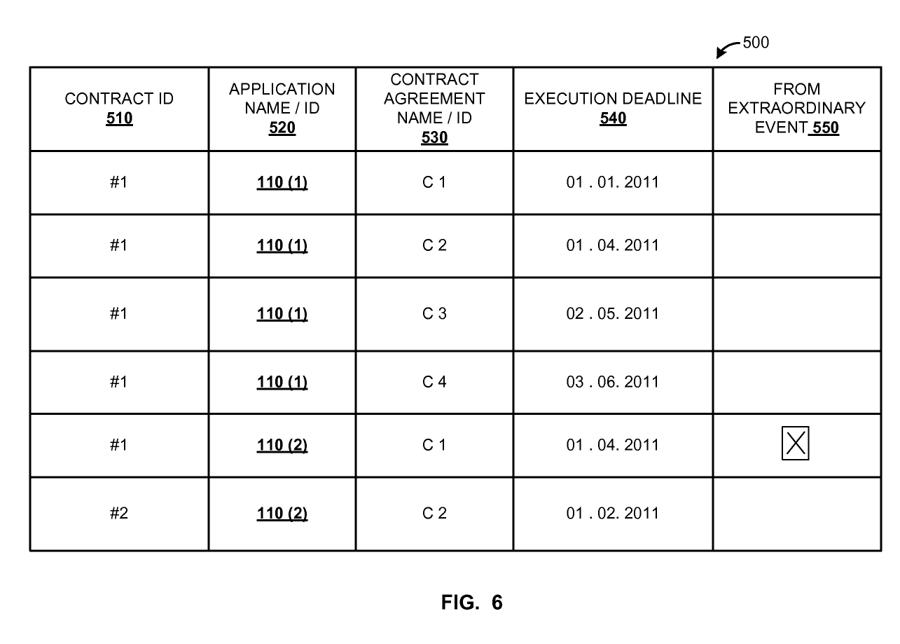

Essentially, the extraordinary event (stored in the event table 410) and the values of the periodic data (p1-pm) (i.e., values of the fields F1-Fm) of the contract agreement C1 may be retrieved/read to determine an execution deadline for the contract agreement C1. The execution deadline of the contract agreement C1 may be stored in a transactional database table 500 (refer to FIG. 5). In one embodiment, as illustrated in FIG. 5, the transactional database table 500 may include fields, e.g., contract Id 510, application name/id/number 520 (to identify the periodic contract application or a key field), agreement name/id/number 530 (to identify the contract agreement of the periodic contract application or another key field), the execution deadline field 540 corresponding to the contract agreement, and from extraordinary event 550 (to indicate if the execution deadline is calculated from the extraordinary event). For example, as illustrated in the transactional database table 500 of FIG. 6, the execution deadline for the contract agreement C1 of the periodic contract application 110(1) is 01.01.2011 and the execution deadline for the contract agreement C1 of the periodic contract application 110(2) is 01.04.2011. Essentially, the transactional database table 500 includes the one or more due contract agreements related to the corresponding one or more periodic contract applications 110 (1-n). For example, in one embodiment, the transactional database table 500 may include the following corresponding to the periodic contract application 110(1) (i.e., Bank Statement):
Contract agreement C1 monthly statement is due on 01.01.2011;
Contract agreement C2 monthly statement is due on 01.04.2011; and
Contract agreement C3 yearly statement is due on 02.05.2011.

Based upon their respective execution deadline, the contract agreements are executed. For example, the contract agreement C1 may be executed on the execution deadline, i.e., 01.01.2011. In one embodiment, the contract management module 140 periodically executes the contract agreement C1, based upon its execution deadline. Essentially, the contract agreement C1 (associated with the periodic contract application 110(1)) may be executed by executing the business dependent logic (BDL) of the associated periodic contract application 110(1). In one embodiment, the business dependent logic (BDL) are executed using the values of the one or more application specific master data (ASM) (f1-fn) specified for the contract agreement C1.

Essentially, the one or more contract agreements related to the corresponding one or more periodic contract applications 110 (1-n) may be executed automatically based upon their respective execution deadline. For example, the contract agreements (C1-Cn) related to the periodic contract application 110(1) may be executed automatically based upon their respective execution deadline. The contract management module 140 automatically executes the one or more due contract agreements of the corresponding periodic contract applications 110 (1-n) (e.g., parallelized mass run). After execution of the contract agreement, the contract management module 140 automatically updates the execution deadline (i.e., determines and stores the next execution deadline) of the executed contract agreement. For example, the execution deadline of the contract agreement C1 may be updated after every execution of the contract agreement C1. In one embodiment, the execution deadline of the contract agreement C1 may be updated when the end user updates or modifies the one or more periodic data (p1-pn) and/or the extraordinary event(s) related to the contract agreement C1.

In one embodiment, the parallel execution of the one or more due contract agreements (i.e., the parallelized mass run) comprises executing a logging function and a post processing function (i.e., an error handling function). The logging function determines/lists the one or more contract agreements that are executed successfully and the one or more contract agreements that are not successfully executed. The post processing function lists the contract agreements that are not executed successfully along with the reason(s) for unsuccessful execution of the contract agreements. The end user may take appropriate action/step to overcome the unsuccessful execution of the contract agreement. For example, if the reason for unsuccessful execution of the contract agreement C1 is ‘receiver's address not provided’ then the end user may provide the receiver's address to overcome the unsuccessful execution of the contract agreement C1. Once the receiver's address is provided (correction is done), the contract agreement C1 gets executed automatically. In one embodiment, the end user may trigger a selectable button (e.g., a restart button) to execute the contract agreement C1.

The parallelized mass run may be triggered automatically by the contract management module 140 or manually by the end user. An icon or selectable button may be provided to manually trigger the mass run. In one embodiment, the mass run may be automatically triggered on a real time basis (i.e., may always be switched on). In another embodiment, the mass run may be triggered automatically after a predefine time interval. The predefined time interval may be provided by the developer or the end user.

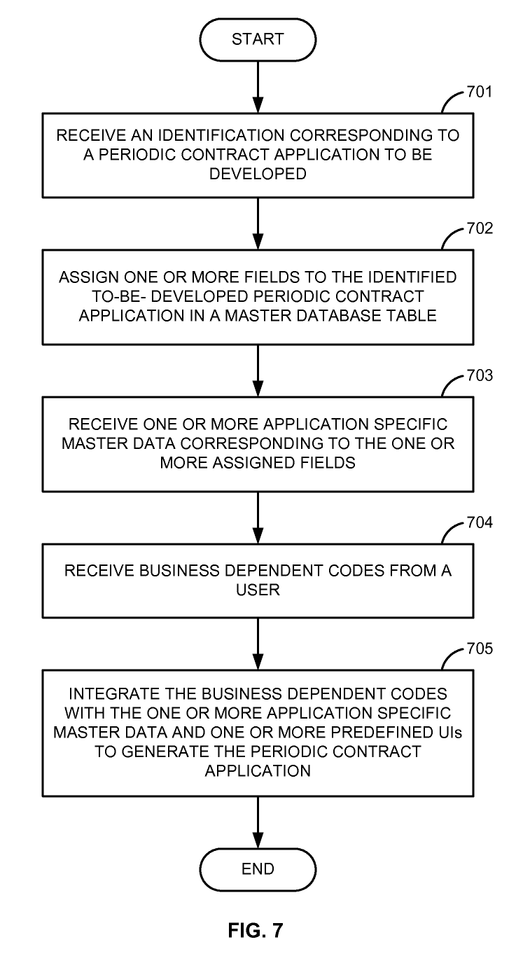

FIG. 7 is a flowchart illustrating a method for developing the periodic contract applications 110 (1-n). Essentially, the user (developer) provides the identification corresponding to the to-be-developed periodic contract application 110(1) at step 701. Once the identification is received, the to-be-developed periodic contract application 110(1) gets registered, the contract management module 140 assigns the one or more fields (f1-fn) to the to-be developed periodic contract application 110(1) in the master database table 130 at step 702. The user may define the one or more application specific master data (ASM) corresponding to the one or more assigned fields (f1-fn) at step 703. Essentially, the user also defines the attributes for the application specific master data (ASM) (i.e., fields (f1-fn)). For example, the user may define the type of the application specific master data (ASM) or field, i.e., whether the application specific master data (ASM) or field is alphanumeric, numeric, or alphabetic, etc., or the length (size) of the application specific master data (ASM) or field, i.e., 20 characters long, 40 characters long, etc. The user includes or enters the business dependent logic (BDL) through the configurable module 150 at step 704. Once the business dependent logic (BDL) are entered, the contract management module 140 integrates the business dependent logic (BDL) with the application specific master data (ASM) and the one or more predefined UIs (e.g., the UI 200) to generate the periodic contract application 110(1) at step 705.

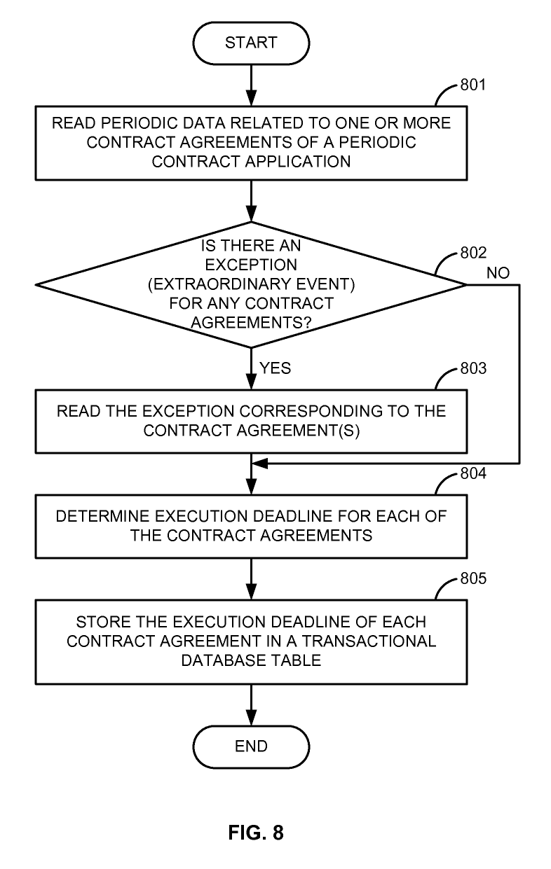

FIG. 8 is a flowchart illustrating a method for determining and storing the execution deadline for the one or more contract agreements (C1-Cn) of the periodic contract application 110(1). Essentially, the values of the periodic data (p1-pm) related to the contract agreements (C1-Cn) of the periodic contract application 110(1) are read at step 801. It is then determined if the exception or extraordinary event is specified for any of the contract agreements (C1-Cn) in the event table 410 at step 802. If the exception is specified for any of the contract agreements (C1-Cn) (step 802: YES), the exception related to the corresponding contract agreement(s) is read at step 803. Based upon the periodic data and the corresponding exception, the execution deadline for the corresponding contract agreement(s) is determined at step 804. In case the exception is not specified for any of the contract agreements (C1-Cn) (step 802: NO), the execution deadline for the contract agreements (C1-Cn) are determined based upon their respective periodic data at step 804. The execution deadline determined for the contract agreements (C1-Cn) are stored in the transactional database table 500 at step 805.

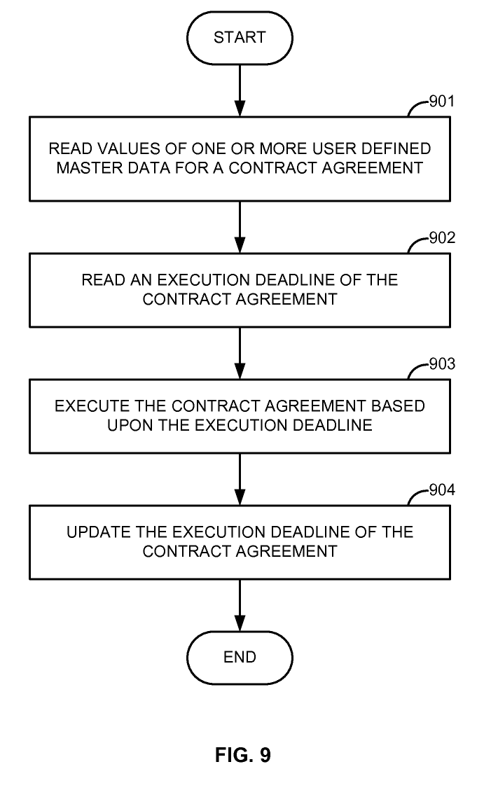

FIG. 9 is a flowchart illustrating a method for executing the contract agreements (C1-Cn) related to the periodic contract applications 110 (1). Essentially, the end user specifies the values of the application specific master data (ASM) (i.e., the fields f1-fn) for the contract agreements (C1-Cn). The value of the application specific master data (ASM) corresponding to the contract agreements (C1-Cn) are received and stored. For example, the value of the application specific master data (ASM) of the contract agreement C1 is received and stored in the master database table 130. The stored value of the application specific master data (ASM) of the contract agreement C1 is read from the master database table 130 at step 901. Once the application specific master data (ASM) is read, the execution deadline of the contract agreement C1 is read from the transactional database table 500 at step 902. Based upon the execution deadline, the contract agreement C1 is executed at step 903. Essentially, the contract agreement C1 is executed based upon its application specific master data (ASM). The contract agreement C1 is executed/implemented by executing the business dependent logic (BDL) related to the periodic contract application 110(1). In one embodiment, the contract management module 140 may provide (submits) the application specific master data (ASM) and the execution deadline of the contract agreement C1 to the configuration module 150. The configuration module 150 implements the business dependent logic (BDL) related to the periodic contract application 110 (1) of the contract agreement C1. Once the contract agreement C1 is executed, the execution deadline (i.e., the next execution deadline) of the executed contract agreement C1 is updated in the transactional database table 500 at step 905.

The embodiments of the invention enable to develop the periodic contract application(s) easily and efficiently. Essentially, the general or common features of the periodic contract applications (e.g., the execution deadline, periodic data, parallelized mass run, logging and post processing functionality, etc) are automatically handled by the system (tool). The developer typically needs to focus on developing the business dependent logic and business specific master data. The developer implements the business dependent logic (e.g., printing of bank statement) and the tool or framework automatically calls back this implementation for execution. Therefore, a quality time and effort of the developer is saved. Further, the invention offers automatic handling of error(s), extra ordinary dates, and the non-working days. Furthermore, the invention minimizes the probability of different types of bugs/errors as the developers need not develop the general or common features. Additionally, the periodic and non-periodic (application specific) master data related to different periodic contract applications can be maintained in the same master database table. Also, the execution deadline related to different contract applications may be maintained in the same transactional database table and the extraordinary events (dates) related to the different periodic contract applications can be maintained in the same event table. Moreover, the invention offers parallel development of several periodic contract applications along with parallel processing/execution of several contract agreements related to various periodic contract applications. Finally, the invention provides the consistent or same look and feel of the predefined UI (including periodic data, etc) in all the developed periodic contract applications.

The embodiments of the invention also enable the end user to maintain the contract agreements and/or the extraordinary events related to the contract agreements. For example, if the end user decides or requires not to proceed further with the contract agreement, the end user can terminate the contract agreement. Essentially, the further execution of the terminated contract agreement is stopped. However, the data related to the terminated contract application is not deleted to enable revision safe reporting. Similarly, the extraordinary events related to the contract agreement can be deleted. The deleted event is marked or flagged as ‘deleted’, the data or value of the deleted event is saved or stored in the event table for future reference/reporting. The embodiments of the invention may also enable migration of the data (e.g., extraordinary events, execution deadline, etc) from a non SAP® system to the SAP® system.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

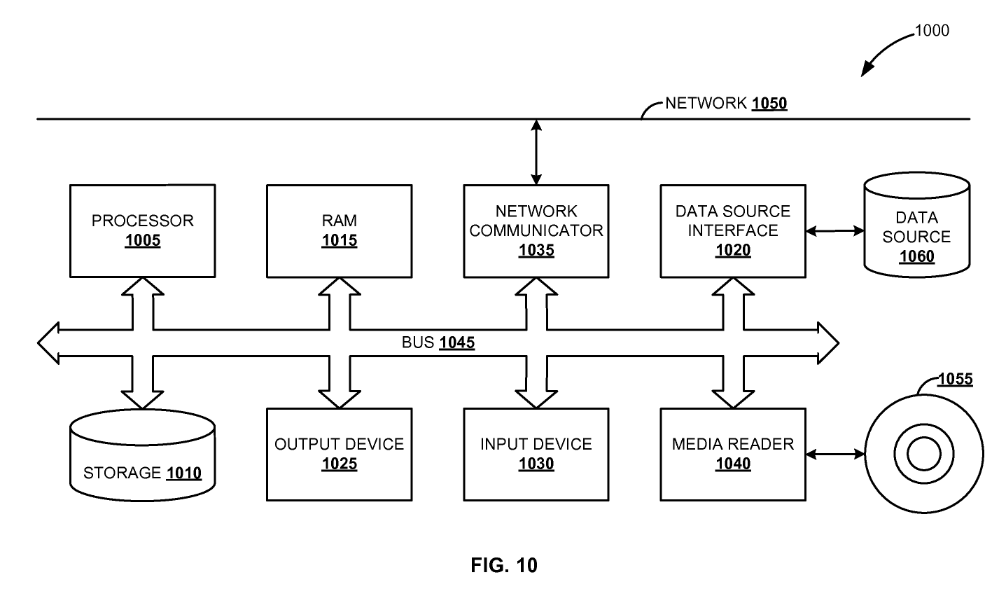

FIG. 10 is a block diagram of an exemplary computer system 1000. The computer system 1000 includes a processor 1005 that executes software instructions or code stored on a computer readable storage medium 1055 to perform the above-illustrated methods of the invention. The computer system 1000 includes a media reader 1040 to read the instructions from the computer readable storage medium 1055 and store the instructions in storage 1010 or in random access memory (RAM) 1015. The storage 1010 provides a large space for keeping static data where at least some instructions could be stored for later execution. The stored instructions may be further compiled to generate other representations of the instructions and dynamically stored in the RAM 1015. The processor 1005 reads instructions from the RAM 1015 and performs actions as instructed. According to one embodiment of the invention, the computer system 1000 further includes an output device 1025 (e.g., a display) to provide at least some of the results of the execution as output including, but not limited to, visual information to users and an input device 1030 to provide a user or another device with means for entering data and/or otherwise interact with the computer system 1000. Each of these output devices 1025 and input devices 1030 could be joined by one or more additional peripherals to further expand the capabilities of the computer system 1000. A network communicator 1035 may be provided to connect the computer system 1000 to a network 1050 and in turn to other devices connected to the network 1050 including other clients, servers, data stores, and interfaces, for instance. The modules of the computer system 1000 are interconnected via a bus 1045. Computer system 1000 includes a data source interface 1020 to access data source 1060. The data source 1060 can be accessed via one or more abstraction layers implemented in hardware or software. For example, the data source 1060 may be accessed by network 1050. In some embodiments the data source 1060 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
receive an identification of at least one periodic contract application to be developed;
assign one or more fields to the identified to-be-developed periodic contract application in a master database table;
receive one or more application specific master data corresponding to the one or more fields assigned to the to-be-developed periodic contract application;
receive business dependent logic; and
integrate the business dependent logic with at least one of the one or more application specific master data and one or more predefined User Interfaces (UIs) including one or more periodic data to generate the periodic contract application.

2. The article of manufacture of claim 1, wherein the to-be-developed periodic contract application is assigned a predefined number of fields in the master database table.

3. The article of manufacture of claim 1, wherein the one or more periodic data is preconfigured as one or more fields of the master database table.

4. The article of manufacture of claim 1, wherein the periodic contract application is associated with one or more contract agreements and wherein for the one or more contract agreements the periodic data is specified.

5. The article of manufacture of claim 4 further comprising instructions which when executed cause the computer to:
store an exception related to the one or more contract agreements in an event table;
based upon at least one of the periodic data and the exception related to the corresponding one or more contract agreements, determine an execution deadline for the corresponding one or more contract agreements; and
store the execution deadline corresponding to the one or more contract agreements in a transactional database table.

6. The article of manufacture of claim 5 further comprising instructions which when executed cause the computer to:
receive and store value of the one or more application specific master data corresponding to the one or more contract agreements of the periodic contract application;
read the execution deadline of the one or more contract agreements;
execute the one or more contract agreements based upon their respective execution deadline; and
update execution deadline for the one or more executed contract agreements, wherein if at least one of the periodic data and the exception related to the corresponding one or more contract agreements are updated, the execution deadline of the corresponding one or more contract agreements are updated based upon the corresponding at least one of the updated periodic data and the updated exception.

7. The article of manufacture of claim 6, wherein the one or more contract agreements are executed by executing the business dependent logic related to the periodic contract application of the corresponding one or more contract agreements.

8. The article of manufacture of claim 6 further comprising instructions which when executed cause the computer to:
execute a parallelized mass run including:
a logging function to determine the one or more contract agreements executed successfully and the one or more contract agreements not executed successfully; and
an error handling function to list the one or more contract agreements not executed successfully and one or more reasons for unsuccessful execution.

9. The article of manufacture of claim 1 further comprising instructions which when executed cause the computer to:
store the generated periodic contract application in a storage medium.

10. A method for developing a periodic contract application, the method comprising:
receiving an identification corresponding to at least one periodic contract application to be developed;
assigning one or more fields to the identified to-be-developed periodic contract application in a master database table;
receiving one or more application specific master data corresponding to the one or more fields assigned to the to-be-developed periodic contract application;
receiving business dependent logic; and
integrating the business dependent logic with at least one of the one or more application specific master data and one or more predefined User Interfaces (UIs) including one or more periodic data to generate the periodic contract application.

11. The method of claim 10, wherein the one or more periodic data is preconfigured as one or more fields of the master database table.

12. The method of claim 11, wherein the periodic contract application is associated with one or more contract agreements and wherein for the one or more contract agreements the periodic data is specified.

13. The method of claim 12 further comprising:
storing an exception related to the one or more contract agreements in an event table;
based upon at least one of the periodic data and the exception related to the corresponding one or more contract agreements, determine an execution deadline for the corresponding one or more contract agreements; and
storing the execution deadline corresponding to the one or more contract agreements in a transactional database table.

14. The method of claim 13 further comprising:
receiving and storing value of the one or more application specific master data corresponding to the one or more contract agreements of the periodic contract application;
reading the execution deadline of the one or more contract agreements;
executing the one or more contract agreements based upon their respective execution deadline; and
updating execution deadline for the one or more executed contract agreements, wherein if at least one of the periodic data and the exception related to the corresponding one or more contract agreements are updated, the execution deadline of the corresponding one or more contract agreements are updated based upon the corresponding at least one of the updated periodic data and the updated exception.

15. The method of claim 14, wherein executing the one or more contract agreements comprises executing the business dependent logic related to the periodic contract application of the corresponding one or more contract agreements.

16. The method of claim 14 further comprising:
executing a parallelized mass run including:
a logging function to determine the one or more contract agreements executed successfully and the one or more contract agreements not executed successfully; and
an error handling function to list the one or more contract agreements not executed successfully and one or more reasons for unsuccessful execution.

17. A computer system for developing a periodic contract application, comprising:
a memory to store program code; and
a processor communicatively coupled to the memory, the processor operable to execute the program code to:
receive an identification of at least one periodic contract application to be developed;
assign one or more fields to the identified to-be-developed periodic contract application in a master database table;
receive one or more application specific master data for the to-be-developed periodic contract application;
receive business dependent logic; and
integrate the business dependent logic with at least one of the one or more application specific master data and one or more predefined User Interfaces (UIs) including one or more periodic data to generate the periodic contract application.

18. The system of claim 17, wherein the one or more periodic data is preconfigured as one or more fields of the master database table and wherein the periodic contract application is associated with one or more contract agreements.

19. The system of claim 18, wherein for the one or more contract agreements the periodic data is specified and wherein the program code further comprises code to:
store an exception related to the one or more contract agreements in an event table;
based upon at least one of the periodic data and the exception related to the corresponding one or more contract agreements, determine an execution deadline for the corresponding one or more contract agreements;
store the execution deadline corresponding to the one or more contract agreements in a transactional database table;
receive and store value of the one or more application specific master data corresponding to the one or more contract agreements of the periodic contract application;
read the execution deadline of the one or more contract agreements;
execute the one or more contract agreements based upon their respective execution deadline; and
update execution deadline for the one or more executed contract agreements, wherein if at least one of the periodic data and the exception related to the corresponding one or more contract agreements are updated, the execution deadline of the corresponding one or more contract agreements are updated based upon the corresponding at least one of the updated periodic data and the updated exception.

20. The system of claim 19, wherein the program code further comprises code to:
execute a parallelized mass run including:
a logging function to determine the one or more contract agreements executed successfully and the one or more contract agreements not executed successfully; and
an error handling function to list the one or more contract agreements not executed successfully and one or more reasons for unsuccessful execution.
